(19) United States
(12) Patent Application Publication
(10) Pub. No.: US 2007/0058263 A1
(43) Pub. Date: Mar. 15, 2007

(54) Apparatus and methods for immersion lithography

(75) Inventors: Ching-Yu Chang, Yuansun Village (TW); Chin-Hsiang Lin, Hsin-Chu (TW)

Correspondence Address: HAYNES AND BOONE, LLP, 901 MAIN STREET, SUITE 3100, DALLAS, TX, 75202, US

(73) Assignee: Taiwan Semiconductor Manufacturing Company, Ltd., Hsin-Chu (TW)

(21) Appl. No.: 11/225,268

(22) Filed: Sep. 13, 2005

(51) Int. Cl. G02B 1/06

(52) U.S. Cl. 359/665

(57) ABSTRACT

The present disclosure provides an immersion lithography system. The system includes: an imaging lens having a front surface, a substrate stage positioned underlying the front surface of the imaging lens, and an immersion fluid retaining structure configured to hold a first fluid at least partially filling a space between the front surface and a substrate on the substrate stage. The immersion fluid retaining structure further comprises at least one of: a first inlet positioned proximate the imaging lens and coupled to a vacuum pump system, the first inlet operable to provide the first fluid to the space between the front surface and the substrate, and a second inlet positioned proximate the imaging lens and operable to provide a second fluid on the substrate.

### BACKGROUND

Immersion lithography typically involves exposing a coated photoresist (resist) to a pattern through a de-ionized water (DIW) filled the space between a project lens and the resist layer for higher resolution. An immersion lithography process may include various processing steps such as photoresist coating, pre-baking, immersion exposing, post-exposure baking, developing, and hard baking. However, the current immersion lithography methods experience micro-bubbles formed in the filled DIW, resulting in pattern defect, pattern distortion, and pattern loss among other issues.

### BRIEF DESCRIPTION OF THE DRAWINGS

Aspects of the present disclosure are best understood from the following detailed description when read with the accompanying figures. It is emphasized that, in accordance with the standard practice in the industry, various features may not be drawn to scale. In fact, the dimensions of the various features may be arbitrarily increased or reduced for clarity of discussion.

FIG. 1 is a schematic view of an embodiment of an immersion lithography apparatus.

FIG. 2 is a schematic view of an embodiment of a degas system integrated with the apparatus of FIG. 1.

FIG. 3 is a flow chart of an embodiment of a method for implementing an immersion lithography process with reduced micro-bubble issues according to aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

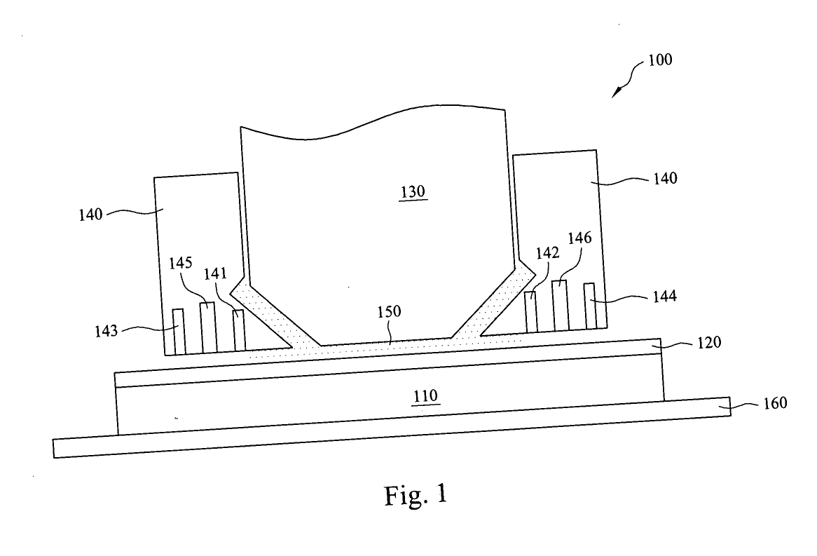

Referring to FIG. 1, illustrated is a schematic view of an embodiment of an immersion lithography apparatus 100 in which a substrate 110 is undergoing immersion lithography processing. The substrate 110 may be a semiconductor wafer having an elementary semiconductor, a compound semiconductor, an alloy semiconductor, or combinations thereof. The semiconductor wafer may include one or more material layers such as poly-silicon, metal, and/or dielectric, to be patterned. The substrate 110 may further include a patterning layer 120 formed thereon. The patterning layer can be a photoresist (resist) layer that is responsive to an exposure process for creating patterns.

The immersion lithography apparatus 100 includes a lens system (or an imaging lens system) 130. The semiconductor wafer may be positioned on a stage 160 under the lens system 130. The lens system 130 may further include or be integral to an illumination system (e.g., the condenser) which may have a single lens or multiple lenses and/or other lens components. For example, the illumination system may include microlens arrays, shadow masks, and/or other structures. The lens system 130 may further include an objective lens which may have a single lens element or a plurality of lens elements. Each lens element may include a transparent substrate and may further include a plurality of coating layers. The transparent substrate may be a conventional objective lens, and may be made of fused silica (SiO₂), calcium-fluoride (CaF₂), lithium fluoride (LiF), barium fluoride (BaF₂), or other suitable material. The materials used for each lens element may be chosen based on the wavelength of light used in the lithography process to minimize absorption and scattering.

The system 100 may include an immersion fluid retaining module 140 for holding an immersion fluid 150 such as water (water solution or de-ionized water) or high n fluid (n is index of refraction, the n value here is larger than 1.44). The immersion fluid retaining module 140 may be positioned proximate (such as around) the lens system 130 and designed for other functions, in addition to holding the immersion fluid. The immersion fluid retaining module 140 and the lens system 130 make up an immersion head.

The immersion fluid retaining module 140 may comprise various apertures (or nozzle) for providing the immersion fluid, providing other fluids, providing purge air for drying, removing any purged fluid, and/or performing other proper functions.

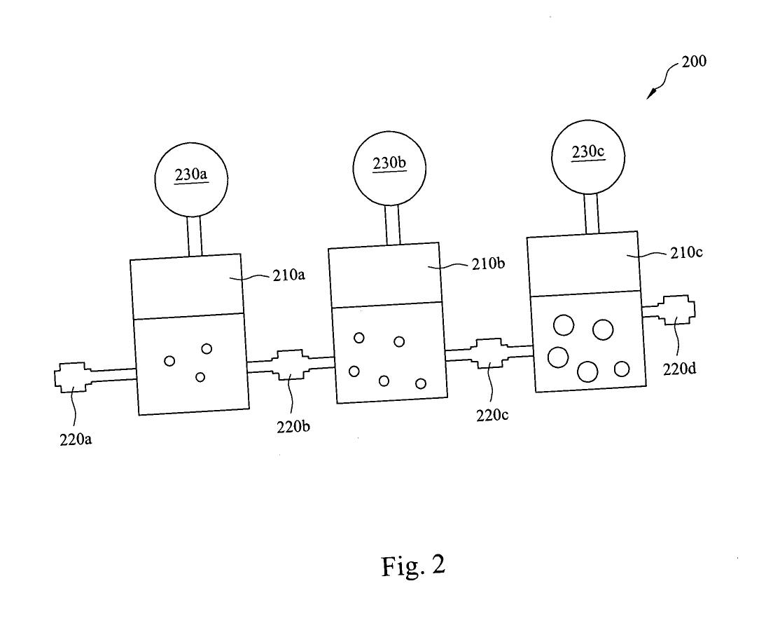

The module 140 may include an aperture such as inlet 141 as an immersion fluid inlet to provide and transfer the immersion fluid 150 into the space between the lens system 130 and the substrate 110 having the resist layer 120 coated thereon. The module 140 may include an aperture 142 as an immersion fluid outlet to remove the purged immersion fluid and any other purged fluid. A degas system may be coupled to or integrated with the module 140 and may function to degas the immersion fluid before filling to the space between the lens system 130 and the substrate 110. An exemplary degas system 200 is illustrated in FIG. 2 as a schematic view. The degas system 200 may include one or more tanks 210a-c to contain the immersion fluid. The tanks 210 may be configured in series through a plurality of flow controllers 220a-d. using master flow controllers (MFCs) or other suitable valves. The degas system 200 may further include a flow controller 220d coupled to the immersion fluid source such as DI water source and another flow controller 220a coupled to the immersion fluid inlet 141. Each tank may be further coupled with a vacuum pump 230a-c, respectively, capable of introducing in to the tank a pressure less than one atmosphere.

In one example, the module 140 may include one or more chemical spray apertures such as apertures 143 and 144. Each aperture 143 and 144 is coupled to a chemical source and operable to spray the associated chemical under the control of a flow controller. The chemical source may include chemicals such as isopropyl alcohol, surfactant, and/or polymer, for example. Each chemical spray aperture can deliver the associated chemical to the resist layer 120 of the substrate 110 positioned on the stage 160, another surface, and/or the space between the imaging lens 130 and the substrate 110. The system 100 may control each chemical spray aperture to deliver the associated chemical alone, with the immersion fluid, with other chemicals, or a combination thereof. The delivery rate and other parameters may also be controllable according to processing recipes.

The module 140 may include one or more gas apertures each is coupled to a gas source and configured to deliver the associated gas such as air, nitrogen, oxygen, argon, or other suitable gas for purging, drying, cleaning, spraying, pre-treating, and/or other suitable functions. In one example, the module may include two air apertures 145 and 146 to deliver air and oxygen, respectively. The apertures are properly configured for optimized performance and may be configured differently from the illustrated one in FIG. 1. For example, the aperture 143 may be positioned closer to the lens than the aperture 145 or vice versa. The system 100 may control each gas aperture to deliver the associated gas alone, with the immersion fluid, chemical(s), other gas(es), or a combination thereof. The delivery rate and other parameters may also be controllable according to processing recipes. The various apertures of module 140 such as the inlet aperture, the outlet aperture, the chemical aperture, and the gas aperture may be configured in a suitable manner for optimal function according to applications and usages. In another example, the various apertures may be partially or completely configured to be integral to the substrate stage 160. Alternatively, the immersion fluid retaining module 140 with various apertures may be integral to the substrate stage 160.

Substrate stage (stage) 160 of system 100 is operable to secure and move the substrate 110 relative to the lens system 130. For example, the stage 160 may be designed to be capable of translational and/or rotational displacement for wafer alignment, stepping, and scanning. The system 100 may be operable to perform additional functions and/or improved exposure quality such as chemical rinsing, spraying a fluid layer before dispensing the immersion fluid, and/or degassing the immersion fluid.

The immersion lithography system 100 may further include a radiation source (not shown). The radiation source may be a suitable ultraviolet (UV) light source. For example, the radiation source may be a mercury lamp having a wavelength of 436 nm (G-line) or 365 nm (I-line); a Krypton Fluoride (KrF) excimer laser with wavelength of 248 nm; an Argon Fluoride (ArF) excimer laser with a wavelength of 193 nm; a Fluoride (F₂) excimer laser with a wavelength of 157 nm; or other light sources having a desired wavelength (e.g., below approximately 100 nm).

A photomask (also referred to as a mask or a reticle) may be introduced between the lens system 130 and the patterning layer 120 during an immersion lithography process. The mask may include a transparent substrate and a patterned absorption layer. The transparent substrate may use fused silica (SiO₂) relatively free of defects, such as borosilicate glass and soda-lime glass. The transparent substrate may use calcium fluoride and/or other suitable materials. The patterned absorption layer may be formed using a plurality of processes and a plurality of materials, such as depositing a metal film made with chromium (Cr) and iron oxide, or an inorganic film made with MoSi, ZrSiO, SiN, and/or TiN. A light beam may be partially or completely blocked when hitting on an absorption region. The absorption layer may be patterned to have one or more openings through which a light beam may travel without being absorbed by the absorption layer.

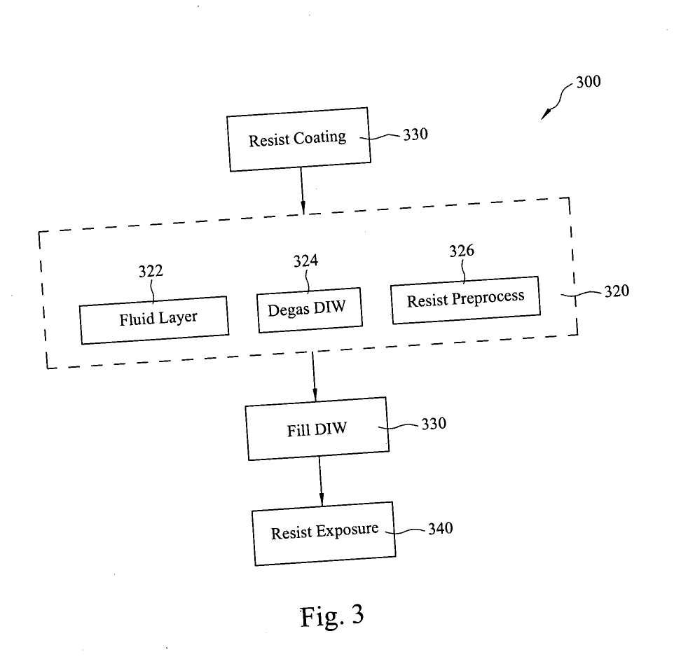

FIG. 3 illustrates a flow chart of an embodiment of an immersion lithography process 300 to reduce micro-bubbles and defects caused thereby. The process 300 may utilize the immersion lithography system 100 and the degas system 200 integrated or coupled together. The process 300 is described below with reference to FIGS. 1-3.

The process 300 may begin at step 310 by forming a resist layer on a semiconductor wafer or other suitable substrate. The resist layer may be formed by a normal coating method such as spin-on coating and/or other suitable processes such as chemical vapor deposition. The resist layer may comprise a suitable resist material such as a chemical amplifier (CA) resist material. Other proper processes, such as soft baking, may be implemented before or after the resist coating.

At step 320, the process 300 may implement a pre-treating process in order to reduce micro-bubbles and/or other associated defects during an immersion exposure. In one example, the pre-treating step 320 may include a process to form a fluid layer on the resist layer coated on the substrate. The fluid layer may be formed by the immersion lithography system 100 and utilize a proper aperture to spray the fluid on the resist layer. The fluid material may include, for example, DI water, surfactant, polymer, isopropyl alcohol, base fluid, acid fluid, solvent, or combinations thereof.

In another example, the pre-treating step 320 may include a degassing process 324 to degas the immersion fluid (e. g. DI water) before dispensing the immersion fluid. The degassing may be performed by the degas system 200 coupled to or integrated with the immersion lithography system 100. The degas system 200 may include one or more pumps coupled in series, each providing a pressure less than about one atmosphere to an associated tank and configured such that the dissolved gas in the immersion fluid can be effectively removed. Multiple pumps as illustrated in FIG. 2 may be used to provide the immersion fluid that is substantially degassed. The degassing may be combined with next step to fill the degassed immersion fluid to the space between the lens system and the substrate.

In another example, the pre-treating step 320 may include a resist preprocess 326. The resist preprocess may utilize a DI-water rinse combined with partial exposure or surfactant. In one option, the resist layer may be partially exposed and then rinsed with DI water for a predefined duration. In another option, the resist layer may be rinsed by a solution of DI water and a surfactant mixed with a predefined ratio. The surfactant may be mixed with DI water in a surfactant source according to a processing recipe and is then sprayed on the resist layer of the substrate through a chemical aperture such as aperture 143. The surfactant is a material that can greatly reduce the surface tension when used in a low concentration. The surfactant may have various types including nonionic, anionic, cationic, or amphoteric. A proper surfactant is compatible with the resist material and can effectively reduce the surface tension of the resist layer. One type surfactant may be utilized or several types of surfactants may be combined for rinsing in order to achieve an optimized effect in reducing the surface tension of the resist layer. The two options may be alternatively used or integrated in various embodiments.

The pre-treating step 320 is designed to reduce the formation of micro-bubbles during filling of the immersion fluid at the next step. The pre-treating processes 322, 324, and 326 may be used alone or combined in various manner for an optimal result. For example, the resist layer may be surfactant/DIW rinsed and then is filled with degassed DI water. In another example, a fluid layer may be formed on the resist layer and then the degassed DI water is filled to the space between the lens system and the substrate. After a pre-treating process, the contact angle between the DIW and the resist layer may be reduced to be less than about 100 degrees. The processes 322 and 326 may be performed at a different chamber and may use different delivery structures.

At step 330, the process 300 may fill the immersion fluid into the space between the lens system 130 and the substrate 110. The immersion fluid may be DI water and may be provided via the inlet 141. The immersion fluid may only partially fill the space between the lens system 130 and the substrate 110. For example, the space under an illumination spot may be filled and the filled immersion fluid may move along with the illumination spot. The immersion fluid may be degassed through the degassing process 324. The top surface of the resist layer 120 may be rinsed with DIW, surfactant/DIW, or partially exposed/DIW rinsed, and is then filled with the immersion fluid.

The process 300 may resume to step 340 by exposing the resist layer 120. The resist layer 120 is illuminated with the radiation energy from the radiation source through the lens system, a patterned mask, and the immersion fluid filled in the space between the lens system and the substrate. The radiation source may be an ultraviolet light source, for example a krypton fluoride (KrF, 248 nm), argon fluoride (ArF, 193 nm), or F2 (157 nm) excimer laser. The wafer is exposed to the radiation for a predetermined amount of time relating to the exposure dose and the intensity of the radiation source.

Other processing steps may be integral to the process 300. For example, a developing process may be implemented after step 340 to remove the exposed (or shielded) resist regions to form a patterned resist layer. The resist layer may be thermal processed through multiple baking steps such as a post exposure baking (PEB) between the exposing and the developing, and a hard baking after the developing.

Thus, the present disclosure provides an immersion lithography system. The system includes an imaging lens having a front surface, a substrate stage positioned underlying the front surface of the imaging lens, and a fluid retaining structure configured to hold a first fluid at least partially filling a space between the front surface and a substrate on the substrate stage. The fluid retaining module further comprises at least one of a first inlet and a second inlet. The first inlet is positioned proximate the imaging lens and coupled to a vacuum pump system, and the first inlet operable to provide the first fluid to the space. The second inlet is positioned proximate the imaging lens and operable to provide a second fluid on the substrate. In the system, the second fluid may be selected from the group consisting of air, nitrogen, oxygen, de-ionized water, alcohol, surfactant, and combinations thereof. The fluid retaining module may be configured around the imaging lens. The vacuum pump system may be operable to degas the first fluid and the first inlet is configured to transfer the first fluid after being degassed.

The present disclosure also provides an immersion lithography apparatus. The apparatus includes an imaging lens having a front surface, a substrate stage positioned underlying the front surface of the imaging lens, a fluid retaining module positioned proximate the imaging lens and configured to hold a fluid at least partially filling a space between the front surface and a substrate on the substrate stage, and a fluid inlet system configured to degas and transfer the fluid to the space between the front surface and the substrate on the substrate stage. In this apparatus, the fluid inlet system may comprise at least one pump configured to degas the first fluid. The pump may introduce to the fluid a pressure less than one atmosphere. The fluid inlet system comprises at least two inlets each operable to deliver fluid to the space.

The present disclosure also provides an immersion photolithography process. The process includes forming a resist layer on a substrate, forming a first fluid layer on the resist layer, dispensing a second fluid to fill a space between an imaging lens and the resist layer, and illuminating the imaging lens to perform a lithographic exposure on the resist layer. In the process, the first fluid layer may comprise a fluid material selected from the group consisting of de-ionized water, surfactant, polymer, isopropyl alcohol, acid fluid, base fluid, solvent, and combinations thereof. The first fluid layer may be formed on the resist layer via a nozzle. The nozzle may be integrated with an immersion head. The first fluid layer may alternatively be formed on the substrate before the resist coating. The second fluid may comprise de-ionized water, degassed high n fluid (for example, H₃PO₄ solution), or degassed de-ionized water. The resist layer may have a contact angle to the second fluid less than 100 degree after forming the first fluid layer on the resist layer.

The present disclosure also provides an immersion photolithography process. The process includes: forming a resist layer on a substrate, pre-treating to reduce defects associated with a first fluid during illumination, dispensing the first fluid to fill a space between an imaging lens and the resist layer formed on the substrate which is positioned on a substrate stage, after the pre-treating, and illuminating the imaging lens to perform a lithographic exposure on the resist layer on the substrate. The pre-treating includes at least one of:

degassing the first fluid;

forming a second fluid layer on the resist layer;

partially exposing the resist layer and de-ionized water rinsing the resist layer; and

rinsing the resist layer with surfactant, acid solution, base solution, solvent, de-ionized water, or combination thereof.

In this process, the first fluid may include de-ionized water. The second fluid may include a fluid material selected from the group consisting of de-ionized water, surfactant, polymer, isopropyl alcohol, and combinations thereof. The degassing the first fluid may comprise utilizing at least one vacuum pump. The resist layer may have a contact angle less than 100 degree after the pre-treating.

The present disclosure also provides an immersion photolithography process. The process includes: forming a resist layer on a substrate, degassing and dispensing de-ionized water or high n fluid to fill a space between an imaging lens and the resist layer formed on the substrate positioned underlying the substrate, and illuminating the imaging lens to perform a lithographic exposure on the resist layer.

Although embodiments of the present disclosure have been described in detail, those skilled in the art should understand that they can make various changes, substitutions and alterations herein without departing from the spirit and scope of the present disclosure.

What is claimed is:

1. An immersion lithography system, comprising:
an imaging lens having a front surface;
a substrate stage positioned underlying the front surface of the imaging lens; and
an immersion fluid retaining structure configured to hold a first fluid at least partially filling a space between the front surface and a substrate on the substrate stage, and the immersion fluid retaining structure further comprising at least one of:
a first inlet positioned proximate the imaging lens and coupled to a vacuum pump system, the first inlet operable to provide the first fluid to the space between the front surface and the substrate; and
a second inlet positioned proximate the imaging lens and operable to provide a second fluid on the substrate.

2. The system of claim 1, wherein the second fluid is selected from the group consisting of air, nitrogen, oxygen, de-ionized water, alcohol, surfactant, and combinations thereof.

3. The system of claim 1, wherein the immersion fluid retaining structure is configured around the imaging lens.

4. The system of claim 1, wherein the vacuum pump system is operable to degas the first fluid and the first inlet is configured to transfer the first fluid after being degassed to the space.

5. An immersion lithography apparatus, comprising:
an imaging lens having a front surface;
a substrate stage positioned underlying the front surface of the imaging lens;
a fluid retaining module positioned proximate the imaging lens and configured to hold a fluid at least partially filling a space between the front surface and a substrate on the substrate stage; and
a fluid inlet system configured to degas and transfer the fluid to the space.

6. The apparatus of claim 5, wherein the fluid inlet system comprises at least one pump configured to degas the fluid.

7. The apparatus of claim 6, wherein the pump introduces to the fluid a pressure less than one atmosphere.

8. The apparatus of claim 5, wherein the fluid inlet system comprises at least two inlets each operable to deliver fluid to the space.

9. An immersion photolithography process comprising:
forming a resist layer on a substrate;
forming a first fluid layer on the resist layer;
dispensing a second fluid to fill a space between an imaging lens and the resist layer; and
illuminating the imaging lens to perform a lithographic exposure on the resist layer.

10. The process of claim 9, wherein the first fluid layer comprises a fluid selected from the group consisting of de-ionized water, surfactant, acid solution, base solution, solvent, polymer, isopropyl alcohol, and combinations thereof.

11. The process of claim 9, wherein the first fluid layer is formed on the resist layer via an nozzle.

12. The process of claim 11, wherein the nozzle is integrated with an immersion head.

13. The process of claim 9, wherein the second fluid comprises de-ionized water.

14. The process of claim 9, wherein the second fluid comprises degassed de-ionized water.

15. The process of claim 9, wherein the second fluid has a contact angle to the resist layer less than 100 degree after forming the first fluid layer on the resist layer.

16. An immersion photolithography process comprising:
forming a resist layer on a substrate;
pre-treating to reduce defects associated with the immersion photolithography process;
dispensing a first fluid to fill a space between an imaging lens and the resist layer formed on the substrate which is positioned on a substrate stage, after the pre-treating; and
illuminating the imaging lens to perform a lithographic exposure on the resist layer.

17. The process of claim 16, wherein the pre-treating comprises at least one of:
degassing the first fluid;
forming a second fluid layer on the resist layer;
partially exposing the resist layer using a radiation source and rinsing the resist layer with de-ionized water (DIW); and
rinsing the resist layer with one of surfactant, acid solution, base solution, solvent, DIW, and combination thereof.

18. The process of claim 17, wherein the first fluid comprises de-ionized water.

19. The process of claim 17, wherein the second fluid comprises a fluid material selected from the group consisting of de-ionized water, surfactant, polymer, isopropyl alcohol, and combinations thereof.

20. The process of claim 17, wherein the degassing the first fluid comprises utilizing at least one vacuum pump.

21. The process of claim 17, wherein the resist layer has a contact angle to the first fluid less than 100 degree after the pre-treating.

22. An immersion photolithography process comprising:
forming a resist layer on a substrate;
degassing and dispensing de-ionized water to fill a space between an imaging lens and the resist layer formed on the substrate positioned underlying the substrate; and
illuminating the imaging lens to perform a lithographic exposure on the resist layer.
